(19) United States
(12) Patent Application Publication
(10) Pub. No.: US 2026/0258686 A1
(43) Pub. Date: Sep. 3, 2026

(54) ADJUSTMENT ARRANGEMENT, IN PARTICULAR A SPINDLE DRIVE, FOR ADJUSTING AN ADJUSTABLE ELEMENT, IN PARTICULAR A FLAP, OF A MOTOR VEHICLE

(71) Applicant: Brose Fahrzeugteile SE & Co. Kommanditgesellschaft, Bamberg, Bamberg (DE)

(72) Inventors: Harald KRÜGER, Bamberg (DE); Sebastian PFEIFER, Walsdorf (DE); Marco SCHRAMM, Seßlach (DE); Tobias ZWOSTA, Wilhelmsthal (DE); Michael SCHNEIDERBANGER, Rattelsdorf (DE); Michael BERTHOLD, Leipzig (DE); Tobias BOSECKER, Bad Rodach (DE); Patrick ZEUß, Bad Rodach (DE); Jochen DESCHNER, Untermerzbach (DE)

(21) Appl. No.: 19/552,821

(22) Filed: Feb. 27, 2026

(30) Foreign Application Priority Data
Feb. 28, 2025 (DE) 102025107784.3

(51) Int. Cl. E05F 1/10; E05F 15/53; E05F 15/622

(52) U.S. Cl. CPC E05F 1/105; E05F 15/53; E05F 15/622; E05Y 2900/546

(57) ABSTRACT

An adjustment arrangement for adjusting an adjustable element of a motor vehicle, which has a motorized or non-motorized drive unit, wherein the drive unit has, as train components, a hollow cylinder and a rod axially guided therein, wherein the adjustment arrangement has a drive spring arrangement with a drive spring, wherein, for guiding the drive spring during operation of the adjustment arrangement, a tubular guide having a circumferential radial guide surface extends outside or inside the drive spring. It is proposed that the circumferential radial guide surface of the tubular guide has a geometry that differs from that of a cylindrical lateral surface, such that the drive spring, during operation of the adjustment arrangement, can only contact the circumferential radial guide surface of the tubular guide in the circumferential direction around the geometric drive axis with individual drive spring circumferential sections.

### CROSS-REFERENCE TO RELATED APPLICATION

This application claims priority pursuant to 35 U.S.C. § 119(a) to German Patent Application No. 102025107784.3, filed Feb. 28, 2025, which application is incorporated herein by reference in its entirety.

### FIELD OF THE INVENTION

The present invention relates to an adjustment arrangement, in particular a spindle drive, for adjusting an adjustable element, in particular a flap, of a motor vehicle according to the preamble of claim 1, and to an adjustment arrangement, in particular a spindle drive, for adjusting an adjustable element, in particular a flap, of a motor vehicle according to the preamble of claim 11.

### BACKGROUND OF THE INVENTION

The term “adjustable element” is to be understood broadly in the present context. It includes, for example, flaps such as tailgates, trunk lids, bonnets, hoods, side doors, cargo hatches or the like, or sliding doors of a motor vehicle.

Different drive types are known for adjusting such an adjustable element, for example a tailgate. Both motor-driven and motorless adjustment arrangements are known. A motor-driven adjustment arrangement is, for example, a spindle drive which, via a drive unit with a drive motor, drives a spindle-spindle nut transmission as a feed transmission to generate linear drive movements. An example of a motorless adjustment arrangement is a gas pressure element that has a drive unit with a gas-filled gas pressure element cylinder and a gas pressure element piston rod axially guided therein, i.e., a push rod with a piston at the end. The gas filled into the cylinder is then pressurized and thus provides a spring force. The drive unit of the spindle drive or the gas pressure element may also include a drive spring arrangement with at least one drive spring, in particular a helical spring, which provides an additional spring force to support the drive movements.

The known prior art (DE10 2017 117 993 A1), from which the invention proceeds, relates to an adjustment arrangement in the form of a spindle drive for adjusting a tailgate with a drive motor and a spindle-spindle nut drive downstream of the drive motor for generating linear drive movements. To transmit the drive movements, two drive connections are provided, which are biased against each other by means of a drive spring. In the known adjustment arrangement, the spindle nut is connected to a spindle guide tube, which serves to guide the spindle protruding through the spindle nut. A separate spring guide tube supports the drive spring in a radial direction relative to the geometric drive axis in such a way that a corresponding radial deflection of the coil spring is avoided.

One challenge here is to reduce operating noise to a minimum. For example, during operation of the tailgate, sticky noises may occur, caused by the movement of the spring coils on the circumferential radial guide surface of the spring guide tube. This phenomenon is caused by the stick-slip effect, in which the drive spring temporarily “sticks” due to friction and then suddenly releases. The stronger the contact pressure of the drive spring on the guide surface, the more pronounced the noise.

### SUMMARY OF THE INVENTION

The invention is based on the object of designing and developing the known adjustment arrangement in such a way that further optimization is achieved with regard to the operating noises.

The above object is achieved by the features of the characterizing part of claim 1.

The main consideration is to reduce the contact area between the drive spring and a guide surface of a tubular guide associated with the drive spring, in particular a spring guide tube or housing tube, so that full contact is avoided. In this way, the difference between static and sliding friction can be equalized, effectively preventing static noise. At the same time, this also reduces wear and tear.

Specifically, it is proposed that the circumferential radial guide surface of the tubular guide has a geometry that differs from that of a cylindrical lateral surface, such that the drive spring, during operation of the adjustment arrangement, can only contact the circumferential radial guide surface of the tubular guide in the circumferential direction around the geometric drive axis with individual drive spring circumferential sections. By modifying the guide surface in this way, the stick-slip effect is avoided and wear is reduced.

claim 2 specifies particularly preferred embodiments of the circumferential radial guide surface of the tubular guide, which aim to reduce the number of contact points between the drive spring and the guide surface. Furthermore, the non-circular contour can contribute to improved stability of the tubular guide.

In claim 3, the drive spring is defined as a helical spring as a particularly preferred embodiment. This has, in particular, round spring coils and is preferably cylindrical in design. Such a drive spring offers a particularly simple and cost-effective solution for providing an axial spring force.

According to the particularly preferred embodiment according to claim 4, the adjustment arrangement has a drive housing, wherein one of the housing tubes is used to guide the drive spring. This allows for a simple and elegant solution for guiding the drive spring by integrating the guide directly into the drive housing. This allows the number of components to be reduced and assembly to be made easier.

According to claims 5 and 6, the inner housing tube can also be shaped in such a way that it reduces not only the contact area to the drive spring, but also to the outer housing tube, so that a full contact is avoided here as well. This contributes to improving the running properties between the housing tubes and can reduce friction and wear in this area.

According to the particularly preferred embodiment according to claim 7, the tubular guide has a uniform wall thickness all around. This allows for an even distribution of force within the tubular guide and prevents certain areas of the guide from being excessively stressed, which contributes to an increased service life of the adjustment arrangement.

According to the particularly preferred embodiment according to claim 8, a spring guide tube, i.e. a tubular component different from the aforementioned housing tubes, serves as a guide for the drive spring inside or outside the drive spring. In this case, the spring guide tube is preferably designed as proposed, so that a full contact of the drive spring is avoided.

According to the preferred embodiment according to claim 9, the adjustment arrangement is designed as a spindle drive with a spindle-spindle nut drive or as a gas pressure element with a gas-filled gas pressure element cylinder and a gas pressure element piston rod axially guided therein, or as a purely mechanical spring-driven, in particular purely linearly adjustable, piston-cylinder arrangement.

According to claim 10, the spring guide tube simultaneously forms an anti-rotation device for the spindle nut, thus also forming a torsion tube to convert the rotary movement of the spindle into a linear movement of the spindle nut and the spindle guide tube.

According to a further teaching according to claim 11, which has independent significance, a further adjustment arrangement, in particular a spindle drive, for adjusting an adjustable element, in particular a flap, of a motor vehicle is claimed, wherein the adjustment arrangement for transmitting linear drive movements to the motor vehicle has two joint parts adjustable relative to each other along a geometric drive axis between a retracted position and an extended position, each of which forms a drive connection with a counter-joint part on the motor vehicle side for coupling to the adjustable element on the one hand and to the motor vehicle on the other hand, wherein the adjustment arrangement has a motorized or non-motorized drive unit, wherein the drive unit has a drive train with several drive-coupled train components in order to transmit a force introduced into the drive connections, wherein the drive unit has, as train components, a hollow cylinder and a rod axially guided therein, wherein one of the joint parts is axially fixedly coupled to the hollow cylinder and the other of the joint parts is axially fixedly coupled to the rod, wherein the adjustment arrangement has a drive housing with an outer housing tube and an inner housing tube, which, during an adjustment between the retracted position and the extended position, telescopically converge into each other, and wherein, for guiding the inner housing tube on the outer housing tube during operation of the adjustment arrangement, the inner housing tube has a circumferential radial outer surface.

It is essential that the circumferential radial outer surface of the inner housing tube has a geometry that differs from that of a cylindrical lateral surface, such that the outer housing tube, during operation of the adjustment arrangement, can only touch the circumferential radial outer surface in the circumferential direction around the geometric drive axis with individual housing tube circumferential sections.

The inner housing tube is shaped in such a way as to reduce the contact area with the outer housing tube, thus avoiding full contact. This contributes to improving the running properties between the housing tubes and can reduce friction and wear in this area.

Reference may be made to all the statements relating to the proposed adjustment arrangement according to the first teaching.

### BRIEF DESCRIPTION OF THE DRAWINGS

In the following, the invention is explained in more detail with reference to a drawing that merely represents exemplary embodiments. In the drawing:

FIG. 1 shows a schematic perspective view of the rear of a motor vehicle with a proposed adjustment arrangement;

FIG. 2 shows a sectional view of a proposed adjustment arrangement a) in a retracted position and b) in an extended position; and,

FIG. 3 shows enlarged sectional views of a detail of the proposed adjustment arrangement according to FIG. 2 and two variants in cross-section.

### DETAILED DESCRIPTION OF THE INVENTION

An adjustment arrangement 1 shown in the figures can be designed as the motor-driven adjustment arrangement 1, here and preferably as a spindle drive 2 in a manner to be explained below, but also in principle as the motorless adjustment arrangement 1, for example as a gas pressure element 3 in a manner to be explained below.

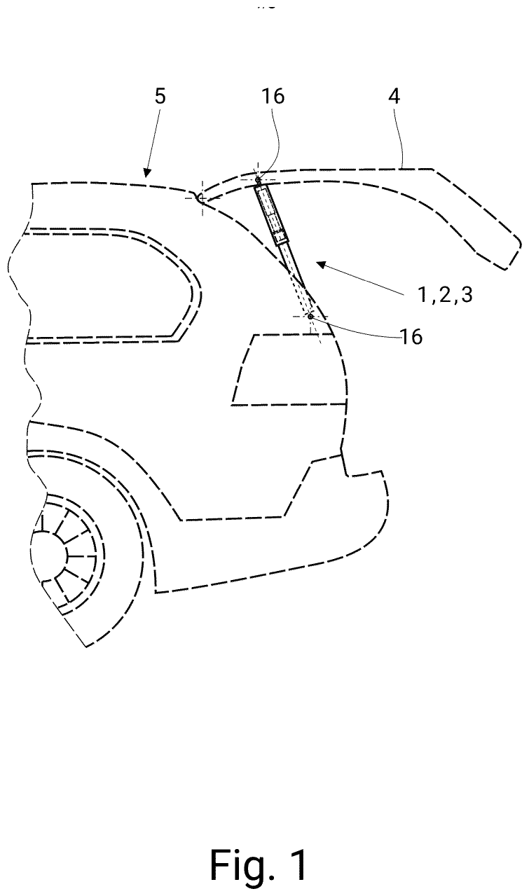

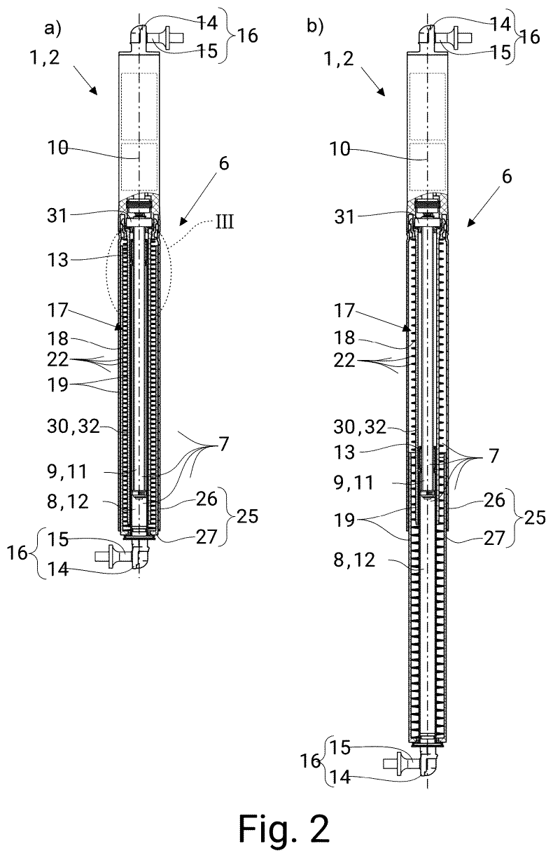

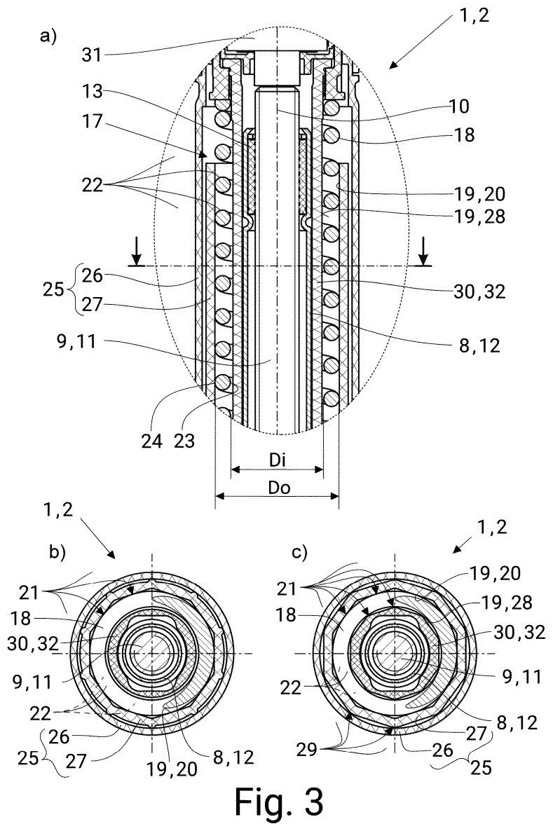

The proposed adjustment arrangement 1 is further described with reference to FIGS. 2 and 3, which here show a motorized and at the same time spring-driven adjustment of an adjustable element 4, in particular a flap, of a motor vehicle 5. The adjustable element 4 according to FIG. 1 is here preferably a tailgate of the motor vehicle 5. Regarding other configurations of the adjustable element 4, reference is made to the list in the introductory part of the description.

Several, in particular two, adjustment arrangements 1 for adjusting the adjustable element 4 may also be provided. In particular, the motor-driven adjustment arrangement 1 and the motorless adjustment arrangement 1 can be provided.

The adjustment arrangements 1 in the figures each have a drive unit 6, which, as force- or torque-transmitting train components 7, has a hollow cylinder 8 and a rod 9 axially guided therein, which can be made of solid material (FIG. 3) or designed as a hollow body. The hollow cylinder 8 and the rod 9 are biased against each other, here and preferably in the extended position of the adjustment arrangement 1. The extended position is achieved here in the state mounted on the motor vehicle 5 when the adjustable element 4 or the flap is in the fully open position (FIG. 1, FIG. 2b). Accordingly, the retracted position of the adjustment arrangement 1 is reached when the adjustable element 4 or the flap is in the fully closed position (FIG. 2a). “Axial” here and subsequently always means parallel to a geometric drive axis 10 of the adjustment arrangement 1.

In the spindle drive 2 as the adjustment arrangement 1, the rod 9 is here and preferably a spindle 11 and the hollow cylinder 8 is a spindle guide tube 12 with a spindle nut 13 arranged axially fixed and rotationally fixed thereto, meshing with the spindle 11 via a screw engagement. Such a spindle-spindle nut drive is well known and requires no further explanation here. The spindle-spindle nut drive can be operated in the usual manner here and preferably via an optional drive motor of the motorized drive unit 6 in this case.

In this context, the term “axially fixed” refers to a form-fit and/or force-fit and/or material-fit connection or an integral connection (one-piece design).

According to another embodiment, the proposed adjustment arrangement 1 can also be purely spring-driven, and thus also serve for non-motorized, exclusively spring-driven adjustment of the adjustable element 4. In this case, the proposed adjustment arrangement 1 has the non-motorized drive unit 6. Such the adjustment arrangement 1 can be designed as the gas pressure element 3, but also, in principle, as a purely mechanical spring-driven piston-cylinder arrangement, in particular as a purely linearly adjustable piston-cylinder arrangement or as the (then motorless) spindle drive 2.

The adjustment arrangement 1 also has, in the case of the gas pressure element 3 as adjustment arrangement 1, the force- or torque-transmitting train components 7 hollow cylinder 8 and rod 9 coupled to each other, which will be explained in more detail below. In this case, the hollow cylinder 8 and the rod 9 are biased against each other, among other things by means of a gas filled into the hollow cylinder 8, in particular also in the extended position. In a purely mechanical spring-driven piston-cylinder arrangement, the adjustment arrangement 1 also has the force- or torque-transmitting train components 7 hollow cylinder 8 and rod 9 coupled to each other, which, however, especially also in the extended position, are only mechanically spring-loaded and not biased against each other by means of a gas filled into the hollow cylinder 8. The following applies accordingly not only to the motorized spindle drive 2 and the gas pressure element 3, but equally to a purely mechanical spring-driven piston-cylinder arrangement.

To transmit linear drive movements to the motor vehicle 5, the adjustment arrangements 1 shown in the figures each have at least two joint parts 14 which are adjustable to each other along the geometric drive axis 10 between a retracted position and an extended position and which are here and preferably identical in construction. The upper joint part 14 shown in FIGS. 1 and 2, together with a vehicle-side counter-joint part 15, which is arranged here on the adjustable element 4, forms a first drive connection 16 for coupling with the adjustable element 4. The lower joint part 14 shown in FIGS. 1 and 2, together with the vehicle-side counter-joint part 15, which is arranged here on the vehicle body 5, forms the second drive connection 16 for coupling with the rest of the motor vehicle 5. Here, and preferably, the two joint parts 14 each have a ball socket which is articulated to a ball head of the respective counter-joint part 15. In principle, it is also conceivable that the joint parts 14 have a ball head and the counter-joint part 15 has a ball socket.

As FIG. 2 shows, one joint part 14 is axially fixed to the hollow cylinder 8 and the other joint part 14—in the case of the spindle drive 2 via the drive motor and an optional reduction gear—is axially fixed to the rod 9.

Furthermore, the proposed adjustment arrangement 1, as part of the drive unit 6, has a drive spring arrangement 17 with at least one drive spring 18, here exactly one drive spring 18, wherein the drive spring arrangement 17 acts on the two joint parts 14 by providing an axial spring force, here and preferably compressive force, alternatively also tensile force (not shown), i.e., is pre-tensioned on them. By means of the drive spring arrangement 17, and in the case of the gas pressure element 3 additionally by the gas filled into the hollow cylinder 8, the joint parts 14 are biased against each other, here in the extended position. The at least one drive spring 18, here exactly one drive spring 18, is in particular a helical spring and here and preferably a helical compression spring. In principle, according to another embodiment not shown here, it is also conceivable to provide a helical extension spring as part of the drive spring arrangement 17, in addition to or as an alternative to a helical compression spring.

To guide the drive spring 18 during operation of the adjustment arrangement 1, a tubular guide 19, which has a circumferential radial guide surface 20, runs outside or inside the drive spring 18, wherein this can be a housing part or a component different from it, which will be explained in more detail below. In FIG. 3b a single such tubular guide is provided, namely radially outside the drive spring. In FIG. 3c two such tubular guides are provided, namely one also radially outside the drive spring, and another still inside the drive spring.

The embodiment shown in the figures, and which is preferred in this respect, relates to the adjustment arrangement 1, in particular the spindle drive 2, for adjusting the adjustable element 4, in particular a flap, of the motor vehicle 5, wherein the adjustment arrangement 1 has two joint parts 14 adjustable relative to each other along a geometric drive axis 10 between a retracted position and an extended position for transmitting linear drive movements to the motor vehicle 5, each of which forms the drive connection 16 with the counter-joint part 15 on the motor vehicle side for coupling to the adjustable element 4 on the one hand and to the motor vehicle 5 on the other, wherein the adjustment arrangement 1 has a motorized or non-motorized drive unit 6, wherein the drive unit 6 has a drive train with several train components 7 coupled to each other in a drive-based, i.e., force- or torque-transmitting, manner in order to transmit a force introduced into the drive connections 16, wherein the drive unit 6 has, the train components 7, the hollow cylinder 8 and the rod 9 axially guided therein, wherein one of the joint parts 14 is axially fixed to the hollow cylinder 8 and the other of the joint parts 14 is axially fixed to the rod 9, wherein the adjustment arrangement 1 has the drive spring arrangement 17 with the drive spring 18 (or with several drive springs 18) which acts on the two joint parts 14 by providing an axial spring force, wherein the tubular guide 19, which has the circumferential radial guide surface 20, extends outside or inside the drive spring 18 to guide the drive spring 18 during operation of the adjustment arrangement 1. The guide surface 20 extends at least along a part, preferably the largest part, of the axial extension of the tubular guide 19, that is, the tubular component that serves to guide the drive spring 18.

Depending on which component forms the tubular guide 19, the radial guide surface 20 circumferential around the geometric drive axis 10 is either the radial inner surface of the tubular guide (FIGS. 3b and 3c) or the radial outer surface of the tubular guide 19 (FIG. 3c), which will be explained further below. To guide the drive spring 18, the tubular guide 19 can also run outside and inside the drive spring 18, wherein one tubular guide 19 has a radially inwardly directed guide surface 20 and the other tubular guide 19 has a radially outwardly directed guide surface 20 (FIG. 3c).

It is essential that the circumferential radial guide surface 20 of the tubular guide 19 has a geometry that differs from that of a cylindrical lateral surface, such that the drive spring 18, in operation of the adjustment arrangement 1, can only contact the circumferential radial guide surface 20 of the tubular guide 19 in the circumferential direction around the geometric drive axis 10 with an individual drive spring circumferential sections 21. The contact area between the drive spring and the guide surface of the tubular guide associated with the drive spring is thereby reduced, so that full contact is avoided. In this way, the difference between static and sliding friction can be equalized, effectively preventing static noise. At the same time, this also reduces wear and tear

“Drive spring circumferential sections” 21 are sections of the radial outer surface and/or the radial inner surface of a respective of a spring coils 22 of the drive spring 18 that are spaced apart from each other in the circumferential direction. Accordingly, the circumferential radial guide surface 20 of the tubular guide 19 is only in contact with the drive spring 18 over certain partial areas of its circumference. Therefore, there is no full contact, but in particular only a point contact of the guide surface 20 on the drive spring 18.

Furthermore, it is preferably provided that the circumferential radial guide surface 20 of the tubular guide 19 has a non-circular contour in cross-section, preferably a polygonal contour.

“In cross-section” here means, as in FIGS. 3b and 3c, always the section orthogonal to the geometric drive axis 10.

A non-circular contour is a particularly preferred solution to ensure that the drive spring 18 can only contact the guide surface 20 in the circumferential direction around the geometric drive axis 10 with the individual drive spring circumferential sections 21.

In this context and in the following, a polygonal contour is understood to be, in general, a contour that has several corners which are connected to each other by an arbitrarily running connecting line, in particular a straight or simply or multiply curved connecting line. This comprises a polygonal contour, that is, a contour consisting of several straight line segments connected at corners. Examples include a rectangle, a hexagon, a decagon (radially inside according to FIG. 3b) and a decagon (radially inside and radially outside according to FIG. 3c), or the like, but also a circular basic contour supplemented by regularly or irregularly arranged, outwardly directed projections that define the corners (FIG. 3b) radially outside). The latter corresponds to a cylindrical tube or tube section with axially extending ribs molded onto the outside.

Additionally, or alternatively, the circumferential radial guide surface 20 of the tubular guide 19 has a rotationally symmetrical contour in cross-section in all embodiments. A rotationally symmetrical contour offers particularly uniform guidance in the circumferential direction and is also particularly easy to assemble.

The drive spring 18 is here, and preferably, a helical spring, in particular a helical compression spring. The spring coils 22 of the drive spring 18, which, during operation of the adjustment arrangement 1, radially touch or can touch the circumferential radial guide surface 20 of the tubular guide 19, in particular as here all spring coils 22 of the drive spring 18, are round spring coils 22. Here, and preferably, the drive spring 18 is a cylindrical spring.

Round spring coils 22 are spring coils 22 which extend with a radial inner side 23 and/or a radial outer side 24 around the geometric drive axis 10 along an imaginary cylindrical lateral surface. In the case of a cylindrical spring, this applies to all the spring coils 22, possibly with the exception of the respective end coil, which may have a different shape due to the design. The spring coils 22 have the same inner coil diameter Di and/or outer coil diameter Do. However, it is also conceivable that a varying coil diameter is planned.

According to the embodiment shown in the figures and which is preferred in this respect, it is also preferably provided that the adjustment arrangement 1 has a drive housing 25 with an outer housing tube 26 and an inner housing tube 27, which telescopically slide into each other when adjusting between the retracted position and the extended position. Here, and preferably, the two housing tubes 21, 22 are axially fixed to each of the joint parts 14 that are assigned to them.

In this case, the tubular guide 19 is formed by the inner housing tube 27.

Alternatively or additionally, according to another embodiment not shown here, it can also be provided that the adjustment arrangement 1 has the drive housing 25 with the single housing tube 21, 22 which, when adjusted between the retracted position and the extended position, telescopically slides into the hollow cylinder 8 and that the tubular guide 19 is formed by the single housing tube 21, 22. The circumferential radial guide surface 20 of the tubular guide 19 is thus the radial inner surface of the individual housing tube 21, 22.

To guide the inner housing tube 27 on the outer housing tube 26 during operation of the adjustment arrangement 1, the inner housing tube 27 preferably has a circumferential radial outer surface 28. The radial outer surface 28 of the inner housing tube 27, which surrounds the geometric drive axis, has a geometry that differs from that of a cylindrical lateral surface, such that the outer housing tube 21, 22, in operation of the adjustment arrangement 1, can only touch the circumferential radial outer surface 28 of the inner housing tube 27 in the circumferential direction around the geometric drive axis 10 with an individual housing tube circumferential sections 29.

The term “housing tube circumferential sections” 29 refers to sections of the radial inner surface of the outer housing tube 26 that are spaced apart from each other in the circumferential direction. Accordingly, the circumferential radial outer surface 28 of the inner housing tube 27 is only in contact with the outer housing tube 26 over certain partial areas of its circumference. Therefore, there is no full contact, but, as shown in FIGS. 3b and 3c, in particular only a linear contact of the outer surface 28 of the inner housing tube 27 on the outer housing tube 26. This contributes to improving the running properties between the housing tubes and can reduce friction and wear in this area.

The inner housing tube 27 forms, in particular, said circumferential radial guide surface 20 on the inside and said circumferential radial outer surface 28 on the outside.

Furthermore, it is preferably provided that the circumferential radial outer surface 28 of the inner housing tube 27 has a non-circular contour in cross-section, preferably a polygonal contour. Additionally, or alternatively, the circumferential radial outer surface 28 of the inner housing tube 27 has a rotationally symmetrical contour in cross-section, i.e., in section orthogonal to the geometric drive axis.

An irregular contour also ensures that the outer housing tube 21, 22 can only touch the circumferential radial outer surface 28 of the inner housing tube 27 in the circumferential direction around the geometric drive axis 10 with individual housing tube circumferential sections 29.

In the embodiment shown in FIG. 3c, it is here and preferably also the case that the tubular guide 19 has a uniform wall thickness around the geometric drive axis 10. This is shown in FIG. 3c as an example for the inner housing tube as a tubular guide but can also be provided for other variants of a tubular guide, for example a spring guide tube, as described below.

Furthermore, it is preferably provided that a spring guide tube 30, separate from the drive housing 25, runs inside the drive spring 18 to guide the drive spring 18. The spring guide tube 30 supports the drive spring 18 radially inwards with respect to the geometric drive axis 10 in such a way that a corresponding radial deflection of the coil spring is minimized or avoided. The tubular guide 19 is formed by the spring guide tube 30, wherein the circumferential radial guide surface 20 of the tubular guide 19 is the radial outer surface of the spring guide tube 30.

According to another embodiment, not shown here, it can also be provided that, for guiding the drive spring 18, a spring guide tube 30, separate from the drive housing 25, runs outside the drive spring 18 and that the tubular guide 19 is formed by the spring guide tube 30. The circumferential radial guide surface 20 of the tubular guide 19 is then the radial inner surface of the spring guide tube 30.

As previously explained, the adjustment arrangement is designed as a spindle drive, wherein the train component forming the hollow cylinder is a spindle guide tube with an axially fixed and rotationally fixed spindle nut and the train component forming the rod is a spindle meshing with the spindle nut, in particular designed from solid material (FIGS. 2 and 3).

Alternatively, as mentioned, the adjustment arrangement can also be designed as a gas pressure element, wherein the train component forming the hollow cylinder is a gas-filled gas pressure element cylinder and the train component forming the rod is a gas pressure element piston rod axially guided therein, in particular designed as a hollow body. Or it may be provided that the adjustment arrangement is designed as a purely mechanical spring-driven, in particular purely linearly adjustable, piston-cylinder arrangement, wherein the train component forming the hollow cylinder is a pressure-less cylinder and the train component forming the rod is a piston rod axially guided therein.

In the embodiments shown here and thus preferred, the spring guide tube 30 also forms an anti-rotation device for the spindle nut 13, thus having a multiple function inside.

For this purpose, the spring guide tube is here and preferably rotationally fixed to a bearing 31 of the spindle 11 and forms a so-called torsion tube 32. This converts the rotary motion of the spindle into a linear motion of the spindle nut and the spindle guide tube.

According to a further teaching, the adjustment arrangement 1, in particular the spindle drive 2, is proposed for adjusting the adjustable element 4, in particular a flap, of the motor vehicle 5, wherein the adjustment arrangement 1 has two joint parts 14 adjustable relative to each other along the geometric drive axis 10 between a retracted position and an extended position for transmitting linear drive movements to the motor vehicle 5, each of which forms the drive connection 16 with the counter-joint part 15 on the motor vehicle side for coupling to the adjustable element 4 on the one hand and to the motor vehicle 5 on the other, wherein the adjustment arrangement 1 has the motorized or non-motorized drive unit 6, wherein the drive unit 6 has a drive train with several drive-coupled train components 7 in order to transmit a force introduced into the drive connections 16, wherein the drive unit 6 has as train components 7 the hollow cylinder 8 and the rod 9 axially guided therein, wherein one of the joint parts 14 is connected to the hollow cylinder 8 and the other The joint parts 14 are axially fixedly coupled to the rod 9, wherein the adjustment arrangement 1 has the drive housing 25 with the outer housing tube 26 and the inner housing tube 27, which telescopically slide into each other during an adjustment between the retracted position and the extended position, and wherein, in order to guide the inner housing tube 27 on the outer housing tube 26 during operation of the adjustment arrangement 1, the inner housing tube 27 has the circumferential radial outer surface 28.

Essential to this further teaching is that the circumferential radial outer surface 28 of the inner housing tube 27 has a geometry that deviates from a cylindrical lateral surface, such that the outer housing tube 21, 22, during operation of the adjustment arrangement 1, can only touch the circumferential radial outer surface 28 in the circumferential direction around the geometric drive axis 10 with individual housing tube circumferential sections 29.

As already explained, “housing tube circumferential sections” 29 refer to sections of the radial inner surface of the outer housing tube 26 that are spaced apart from each other in the circumferential direction.

Here, and preferably, the radial inner surface of the outer housing tube 26 in the axial tube section, which touches the circumferential radial outer surface 28 during operation of the adjustment arrangement 1, is cylindrical, i.e., it has no projections over the circumference.

Reference may be made to all the statements relating to the proposed adjustment arrangement 1 according to the first teaching.

1. An adjustment arrangement, in particular a spindle drive, for adjusting an adjustable element, in particular a flap, of a motor vehicle, wherein the adjustment arrangement has two joint parts adjustable relative to each other along a geometric drive axis between a retracted position and an extended position for transmitting linear drive movements to the motor vehicle, each of which forms a drive connection with a counter-joint part on the motor vehicle side for coupling to the adjustable element on the one hand and to the motor vehicle on the other, wherein the adjustment arrangement has a motorized or non-motorized drive unit, wherein the drive unit has a drive train with several drive-coupled train components in order to transmit a force introduced into the drive connections, wherein the drive unit has, as train components, a hollow cylinder and a rod axially guided therein, wherein one of the joint parts is axially fixed to the hollow cylinder and the other of the joint parts is axially fixed to the rod, wherein the adjustment arrangement has a drive spring arrangement with a drive spring which acts on the two joint parts by providing an axial spring force, wherein a tubular guide, which has a circumferential radial guide surface, extends outside or inside the drive spring to guide the drive spring during operation of the adjustment arrangement, wherein the circumferential radial guide surface of the tubular guide has a geometry that differs from that of a cylindrical lateral surface, such that the drive spring, during operation of the adjustment arrangement, can only contact the circumferential radial guide surface of the tubular guide in the circumferential direction around the geometric drive axis with individual drive spring circumferential sections.

2. The adjustment arrangement according to claim 1, wherein the circumferential radial guide surface of the tubular guide has a non-circular contour in cross-section, preferably a polygonal contour, and/or that the circumferential radial guide surface of the tubular guide has a rotationally symmetrical contour in cross-section.

3. The adjustment arrangement according to claim 1, wherein the drive spring is a helical spring, in particular a helical compression spring, and in that the spring coils of the drive spring, which in operation of the adjustment arrangement radially contact or may contact the circumferential radial guide surface of the tubular guide, in particular all spring coils of the drive spring, are round spring coils, preferably in that the drive spring is a cylindrical spring.

4. The adjustment arrangement according to claim 1, wherein the adjustment arrangement has a drive housing with an outer housing tube and an inner housing tube which telescopically slide into each other during an adjustment between the retracted position and the extended position, and that the tubular guide is formed by the inner housing tube.

5. The adjustment arrangement according to claim 4, wherein, for guiding the inner housing tube on the outer housing tube during operation of the adjustment arrangement, the inner housing tube has a circumferential radial outer surface, and in that the circumferential radial outer surface of the inner housing tube has a geometry that deviates from a cylindrical lateral surface, such that the outer housing tube, during operation of the adjustment arrangement, can only touch the circumferential radial outer surface in the circumferential direction around the geometric drive axis with individual housing tube circumferential sections.

6. The adjustment arrangement according to claim 5, wherein the circumferential radial outer surface has a non-circular contour in cross-section, preferably a polygonal contour, and/or in that the circumferential radial outer surface has a rotationally symmetrical contour in cross-section.

7. The adjustment arrangement according to claim 1, wherein the tubular guide has a uniform wall thickness around the geometric drive axis.

8. The adjustment arrangement according to claim 1, wherein a spring guide tube runs inside the drive spring for guiding the drive spring, and in that the tubular guide is formed by the spring guide tube, or in that a spring guide tube runs outside the drive spring for guiding the drive spring, and in that the tubular guide is formed by the spring guide tube.

9. The adjustment arrangement according to claim 1, wherein the adjustment arrangement is designed as a spindle drive, wherein the train component forming the hollow cylinder is a spindle guide tube with a spindle nut axially fixed and rotationally fixed to it, and the train component forming the rod is a spindle meshing with the spindle nut, in particular made of solid material, or that the adjustment arrangement is designed as a gas pressure element, wherein the train component forming the hollow cylinder is a gas-filled gas pressure element cylinder and the train component forming the rod is a gas pressure element piston rod axially guided therein, or that the adjustment arrangement is designed as a purely mechanically spring-driven, in particular purely linearly adjustable, piston-cylinder arrangement, wherein the train component forming the hollow cylinder is a pressure-less cylinder and the train component forming the rod is a piston rod axially guided therein.

10. The adjustment arrangement according to claim 8, wherein the spring guide tube forms an anti-rotation device for the spindle nut.

11. The adjustment arrangement, in particular a spindle drive, for adjusting an adjustable element, in particular a flap, of a motor vehicle, wherein the adjustment arrangement for transmitting linear drive movements to the motor vehicle has two joint parts adjustable relative to each other along a geometric drive axis between a retracted position and an extended position, each of which forms a drive connection with a motor vehicle-side counter-joint part for coupling with the adjustable element on the one hand and the motor vehicle on the other hand, wherein the adjustment arrangement has a motorized or non-motorized drive unit, wherein the drive unit has a drive train with several drive-coupled train components in order to transmit a force introduced into the drive connections, wherein the drive unit has as train components a hollow cylinder and a rod axially guided therein, wherein one of the joint parts is connected to the hollow cylinder and the other of the joint parts are each axially fixedly coupled to the rod, wherein the adjustment arrangement has a drive housing with an outer housing tube and an inner housing tube, which telescopically slide into each other during an adjustment between the retracted position and the extended position, and wherein, for guiding the inner housing tube on the outer housing tube during operation of the adjustment arrangement, the inner housing tube has a circumferential radial outer surface, wherein the circumferential radial outer surface of the inner housing tube has a geometry that differs from that of a cylindrical lateral surface, such that the outer housing tube in operation of the adjustment arrangement can only contact the circumferential radial outer surface in the circumferential direction around the geometric drive axis with individual housing tube circumferential sections.

12. The adjustment arrangement according to claim 2, wherein the drive spring is a helical spring, in particular a helical compression spring, and in that the spring coils of the drive spring, which in operation of the adjustment arrangement radially contact or may contact the circumferential radial guide surface of the tubular guide, in particular all spring coils of the drive spring, are round spring coils, preferably in that the drive spring is a cylindrical spring.

13. The adjustment arrangement according to claim 2, wherein the adjustment arrangement has a drive housing with an outer housing tube and an inner housing tube which telescopically slide into each other during an adjustment between the retracted position and the extended position, and that the tubular guide is formed by the inner housing tube.

14. The adjustment arrangement according to claim 3, wherein the adjustment arrangement has a drive housing with an outer housing tube and an inner housing tube which telescopically slide into each other during an adjustment between the retracted position and the extended position, and that the tubular guide is formed by the inner housing tube.
